(19) United States
(12) Patent Application Publication
(10) Pub. No.: US 2007/0124261 A1
(43) Pub. Date: May 31, 2007

(54) System and method for processing custom postal indicia

(75) Inventors: Andrei Obrea, Seymour, CT (US); Ronald Reichman, Trumbull, CT (US); George M. Macdonald, New Canaan, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/287,728

(22) Filed: Nov. 28, 2005

(51) Int. Cl. G06F 17/00

(52) U.S. Cl. 705/408; 705/1

(57) ABSTRACT

A mailpiece is received in a stream of mail. The mailpiece has a postage stamp thereon. The stamp includes an image. Automatic mail handling equipment detects that the image was identified as being a problematic image and removes the image from the mail stream.

### BACKGROUND

This invention relates generally to mail processing and more particularly to apparatus and methods relating to images carried on user-customized postage stamps.

Personal postage stamp printers have been proposed. With such printers, postal customers, after prepayment of postage, may be allowed to print adhesive postage stamps. According to some proposals, the postal customers may be permitted to create or supply a custom image to be incorporated as part of the postage stamps.

According to other proposals, photographic images or the like may be incorporated in postage meter indicia, and the holder of a postage meter may be allowed to create or supply the image to be included in postage indicia printed by his/her meter.

One issue that may be encountered with such programs is that some customers may choose to provide images that are offensive to the public or otherwise inconsistent with postal regulations. It has been proposed that all images proffered by customers be reviewed for appropriateness by either postal employees or employees of a private company that administers postage meter or stamp printing systems before the images are used in postage stamps or meter indicia. However, experience suggests that in some cases offensive images may slip past screeners.

### SUMMARY

A method is provided that involves receiving a mailpiece in a stream of mail. The mailpiece has a postage stamp on it and the postage stamp includes an image. The method further includes detecting that the image was identified as being problematic problematic, and removing the image from the stream of mail.

An image is “problematic” if a postal authority (e.g., the U.S. Postal Service) or an administrator of a postage printing system believes or suspects that the image does not comply with postal regulations (e.g., as a result of including offensive content), or if the image was printed by a user who has commissioned or generated a stamp that includes a problematic image.

The terms “postage stamp” or “stamp” include postage meter indicia as well as adhesive stamps.

The removal of the problematic image from the mail stream may be accomplished, for example, by obscuring the image or by sorting the mailpiece out of the mail stream so that the mailpiece is diverted from further progress toward delivery to the intended recipient.

The image may be obscured by printing ink over it or, if thermal printing was employed to print the image, by applying heat to the printing stock on which the image was printed.

Identifying a stamp which contains the image considered problematic may include reading data or another code from an identifier (e.g., a barcode) included as part of the stamp. The data that is read may identify either or both of the user who printed/affixed the stamp and a unique identifier for the image in question.

A report may be received by the postal authority or the private administrator that a duplicate of the image was problematic, or that the user who applied the stamp to the mailpiece had used a problematic image. Based on the report, removal of the problematic image from the mail stream may proceed by detecting that a stamp read by screening equipment includes an image reported as problematic or an image issued by a user who was reported to have used a problematic image.

The postage stamp may include a two-dimensional barcode that includes data to indicate where the image is located in the stamp relative to the barcode. The data may also indicate the size of the image. This data may aid automatic equipment in finding the image in order to obscure it.

In another aspect, a two-dimensional barcode is generated that includes the data which indicates the image location and size. Stamps are printed that include a 2-D barcode of this type.

By using the invention, authorities are in a position to suppress distribution of offensive postage stamps, even when initial screeners fail to recognize that proposed images for stamps are unsuitable.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a diagram that illustrates a system provided in accordance with aspects of the invention.

FIG. 2 is a block diagram of a mailpiece processing device that is part of the system of FIG. 1.

FIG. 3 is a flow chart that illustrates a process that may be carried out, in accordance with the invention, in the system of FIG. 1.

FIGS. 4-6 illustrate example mailpieces that may be processed in the system of FIG. 1.

FIG. 7 is a flow chart that illustrates a process that may be carried out in the system of FIG. 1.

### DETAILED DESCRIPTION

The present invention deals with problematic custom postage stamp images that elude screening prior to authorization and are subsequently inducted into the stream of mail handled by a postal authority such as the U.S. Postal Service. Each stamp that includes a custom image (whether pre-printed or a postage meter indicium) may also include data that serves as a unique identifier for the image included in the stamp. The image identifying data is read from the stamps as they pass through the processing equipment of the postal authority. When an image is identified as one that has been reported as problematic, mailpieces which carry that image are detected from the image identifying data included in the stamps on the mailpieces. Suitable actions are then taken such as obscuring the image or outsorting the mailpieces from the mail stream and diverting them from delivery and exposure to the public.

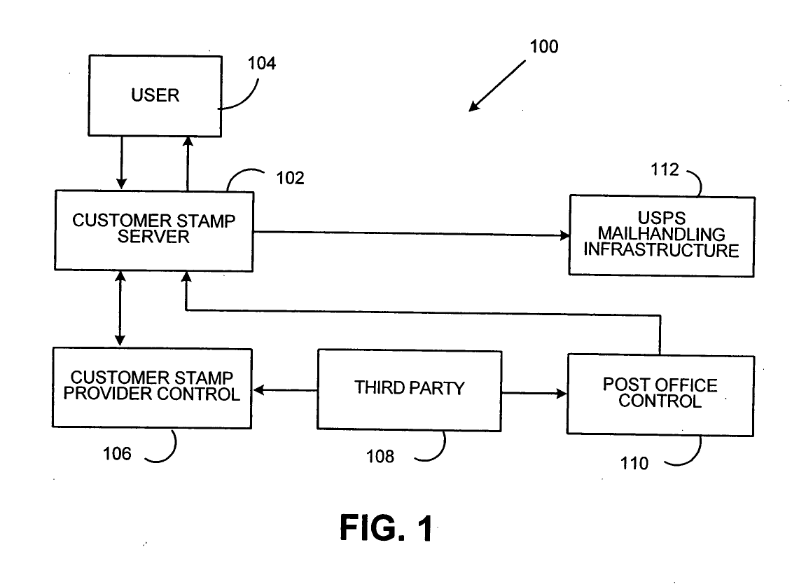

FIG. 1 is a diagram that illustrates a system 100 provided in accordance with aspects of the invention. The system 100 includes a server 102 that manages what will be referred to as a “custom stamp” program. The program may either allow a user 104 to pre-print adhesive postage stamps with a custom image or images provided by the user, or may provide image data for postage meter indicia that incorporate a custom image provided by the user.

In the case of a program for pre-printing custom adhesive stamps, the user 104 may upload (via a user computer which is not separately shown) to the server 102 a custom image which the user wishes to include in pre-printed stamps. The custom image may be forwarded for screening and approval by an employee of the custom stamp system provider 106. Once the image is approved, the server 102 incorporates the image into data that will be downloaded to the user to drive the user's personal stamp printer (also not separately shown). The data to be downloaded also includes a data field (e.g., a two-dimensional barcode) that includes security and identification data. The identification data includes a unique identifier for the user. In addition, the identification data may include an image identifier that uniquely identifies the image either within the universe of custom images, or, more preferably, among all images authorized for use by the particular user. The server may store the custom image in a database in association with the image identifier and the user identifier. Either or both identifiers may be a number or an alphanumeric character string.

In accordance with known proposals, the server 102 also takes steps to secure the user's payment for the stamps to be printed, and then authorizes the personal stamp printer to print the stamps that the user has requested and paid for.

Similarly for a custom stamp program involving postage meter indicia, the user may upload the user's desired custom image to the server 102. Again the custom image is screened and approved by the system provider's employee. The server then downloads the approved image to the user's postage meter (not separately shown), together with an image identifier. As before, the image identifier may be a number or alphanumeric character string that uniquely identifies the image among the universe of custom images in the system, or among all images authorized for use by the particular postage meter. The server stores the custom image in a database in association with the image identifier and a unique identifier for the postage meter.

In what may be a separate transaction, the server 102, or another server which is not shown, may in a conventional manner load postage into the user's postage meter, while securing payment for the postage.

The motivation for this invention is premised on the notion that screening of custom images by the authorities may not be 100% effective, so that some problematic images may slip through, be authorized for printing in custom postage stamps, and enter the mail stream. The invention provides a potential second line of defense against problematic images by allowing the authorities to react to complaints from the public. In addition, or alternatively, the system may respond to postal employees who happen to notice problematic images in the mail stream. In the case illustrated in FIG. 1, it is assumed that a member of the public (third party 108) provides information about a problematic image to the custom stamp provider 106 or to a suitable post office control arm 110 of the postal authority. The custom stamp provider or the postal authority control function may then flag the problematic image (and/or the user who promulgated the image) to the custom stamp server 102. The server 102, in turn, may flag the image to the information and mail handling infrastructure of the postal authority, as represented at 112.

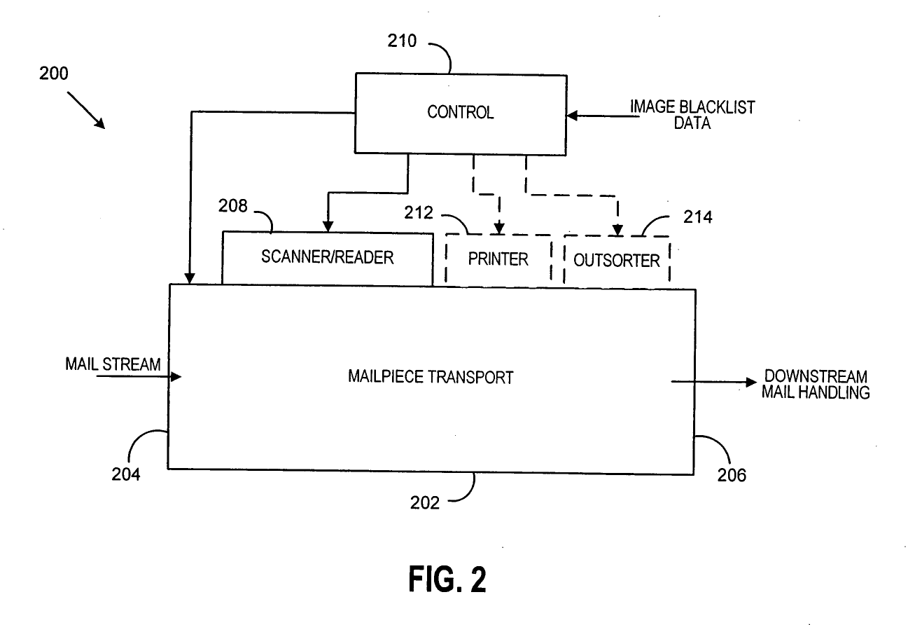

The postal infrastructure 112 may include a network of servers and other computer devices, some of which control mail-scanning, -sorting and -handling equipment. An example of such equipment is illustrated in the form of a block diagram in FIG. 2. The mailpiece handling equipment 200 of FIG. 2 includes a mailpiece transport mechanism 202. The transport mechanism 202 receives a stream of mailpieces at an infeed end 204. The stream of mailpieces exits the transport mechanism 202 at an ouffeed end 206. In addition to image screening functions described below, the mailpiece handling equipment 200 may perform one or more other functions such as postage verification, sorting, routing, appending of barcodes, etc.

The mailpiece handling equipment 200 also includes a scanning/reading module 208 associated with the transport mechanism 202. The scanning/reading module 208 is positioned so as to scan and/or read at least some data carried in printed form by the postage stamps on mailpieces transported by the transport mechanism 202. For example, the module 208 may operate to read at least part of a 2-D barcode included in the stamps. In preferred embodiments, the scanning/reading module 208 is able to scan and/or read the data “on the fly”—i.e., while the mailpiece is in motion—in order to provide maximum throughput. Alternatively, mailpieces may be momentarily paused at the scanning/reading module to facilitate reading of the data from the stamps on the mailpieces.

A control device 210 is included as part of the mailpiece handling equipment 200 and is coupled to the scanning/reading module 208 to receive and/or interpret information captured from the postage stamps by the scanning/reading module 208. The control device may be microprocessor-based, and may include a conventional hardware arrangement of program memory and working memory in communication with a processor programmed to perform functionality described herein.

The control device may operate to control the mailpiece transport mechanism 202. In addition, the control device 210 may receive from an outside source (e.g., from a server—not shown—connected to the control device 210 via a data communication network which is not shown) data that indicates the identifiers of problematic images flagged to the custom stamp server 102 (FIG. 1, not shown in FIG. 2).

The mailpiece handling equipment 200 may also include at least one other module that operates under the control of the control device 210 to deal with problematic images detected by the mailpiece handling equipment 200. For example, the mailpiece handling equipment 200 may include a printer 212 which operates under the control of the control device 210 to print over, and thereby obscure, problematic images in the postage stamps which pass through the transport mechanism 202. The printing may be on the fly or may be applied to a mailpiece that is paused at the printer 212.

Alternatively, the mailpiece handling equipment 200 may include an outsort module 214. The outsort module 214 may operate under the control of the control device 210 to divert from the mail stream each mailpiece which passes through the transport mechanism 202 while carrying a postage stamp that includes an image flagged in the system as problematic.

As will be understood by those who are skilled in the art, the postal authority infrastructure 112 may include many instances of equipment that is structurally and/or functionally equivalent to the mailpiece handling equipment 200.

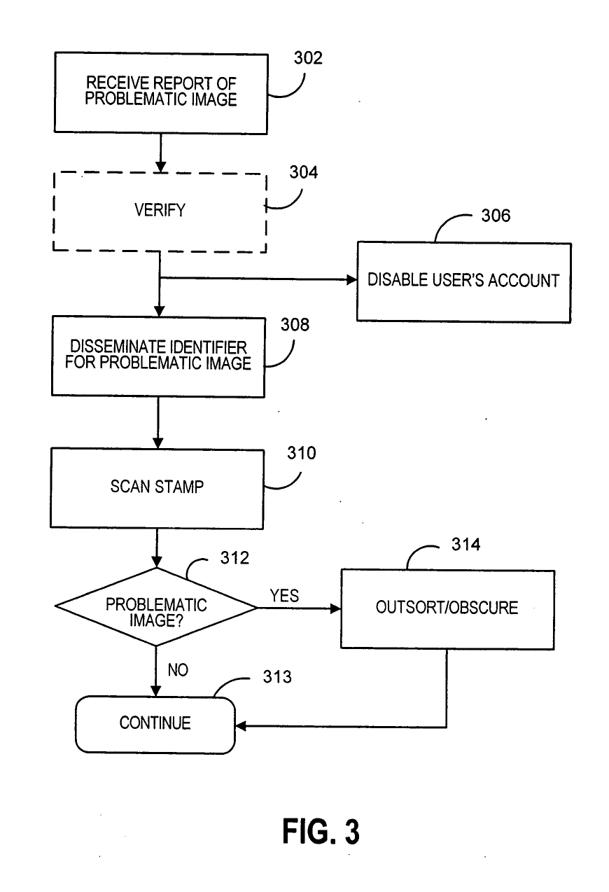

FIG. 3 is a flow chart that illustrates a process that may be carried out in accordance with the invention in the system of FIG. 1. At 302 in FIG. 3, a report of a problematic image is received, either by the custom stamp provider 106 (FIG. 1) or by the postal authority control function 110. It will be assumed that, in some manner, the identifier for the problematic image becomes known to the postal authority and/or to the custom stamp provider. For example, an individual who reports the image may present a mailpiece bearing a stamp that has the image, and the postal authority/custom stamp provider may read an identifier for the image from data (e.g., a 2-D barcode) included in the stamp. Similarly, the reporting individual may present a photocopy of the mailpiece/stamp, and the image identifier may be read from the photocopy.

Once an image has been reported as allegedly problematic, the postal authority/custom stamp provider may take actions (304 in FIG. 3) to verify that the reported image is problematic. For example, the image may be carefully scrutinized and/or compared with regulatory requirements. The scrutiny may be performed by a particularly qualified member of the staff that normally screens custom images proposed by customers, or by an individual or individuals dedicated to considering images reported as allegedly problematic.

In some embodiments, verification that the image is problematic may be omitted, or may be performed when the individual reporting the image is a member of the public or a low level postal employee, but not when the reporting individual is from a particularly trusted category of postal employee.

Following verification that the image is problematic or directly following reporting of the image in other cases/embodiments, the account of the user who disseminated the problematic image may be frozen, as indicated at 306. That is, in the case of an account for pre-printing stamps, further printing of stamps by the user in question may be prevented. In the case where the user holds a postage meter that was used to print the problematic image, further reloading of the meter with postage may be prevented. Of course, the user may be informed that these actions are taken, and that the postal authority/custom stamp provider intends to suppress further use of the problematic image.

Also following verification that the image is problematic, or directly following reporting of the image in other cases/embodiments, the custom stamp server 102 (FIG. 1) may disseminate identifiers (as indicated at 308 in FIG. 3) for the problematic image and/or for the user of the problematic image among various components of the postal authority infrastructure 112. For example, the identifier(s) may be sent to every instance throughout the system of mailpiece handling equipment like the equipment 200 shown in FIG. 2.

From this point forward, the process of FIG. 3 may be performed at the level of the instances of mailpiece handling equipment 200. At 310, the scanning/reading module 208 of the equipment scans/reads the data field of a stamp on a mailpiece that is passing through the equipment, so that the control device is provided with the identifier(s) (user and/or image identifier(s)) for the image on the stamp or for the stamp itself. Then, at 312, the control device 210 determines whether the stamp includes a problematic image. This may be done by determining whether the image/user identifier(s) match the identifier(s) that have been disseminated to the mailpiece handling equipment as pertaining to a problematic image. If a negative determination is made at 312 (i.e., there is no match with a blacklisted identifier or set of identifiers) then handling of the mailpiece proceeds in a normal manner. However, if at 312 it is found that the mailpiece bears a stamp with a problematic image, then action is taken at 314. For example, the mailpiece handling equipment may outsort the mailpiece so that it is diverted from further progress toward delivery to the intended recipient. In addition or alternatively, the mailpiece handling equipment may obscure the problematic image. Following 312 or 314, as appropriate, the process may continue (313).

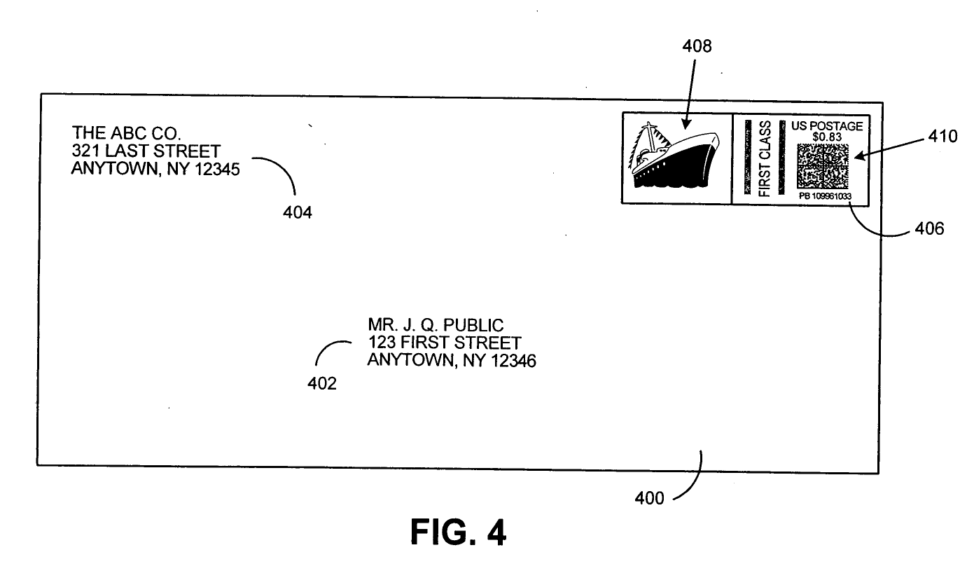

Various issues that may arise in connection with obscuring problematic images will be discussed below. But first reference is made to FIGS. 4-6, which illustrate examples of mailpieces that may be handled by the system described herein.

FIG. 4 shows a mailpiece 400 in the form of an envelope. The mailpiece 400 bears a recipient address 402, a return address 404 and a postage meter indicium 406. The indicium 406 includes a custom image 408 and a data field (2-D barcode) 410. (It will be recognized that in this and other examples, the custom images are not problematic in any obvious way.)

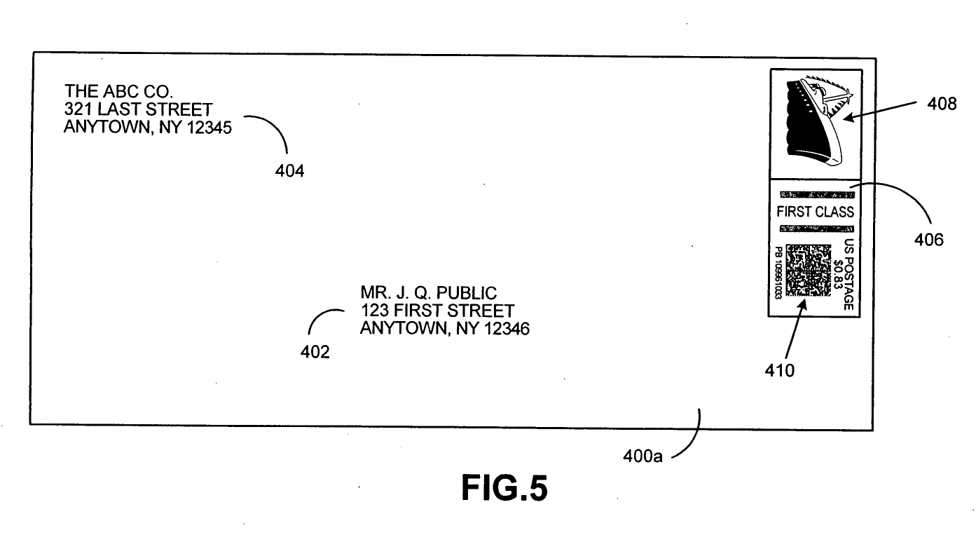

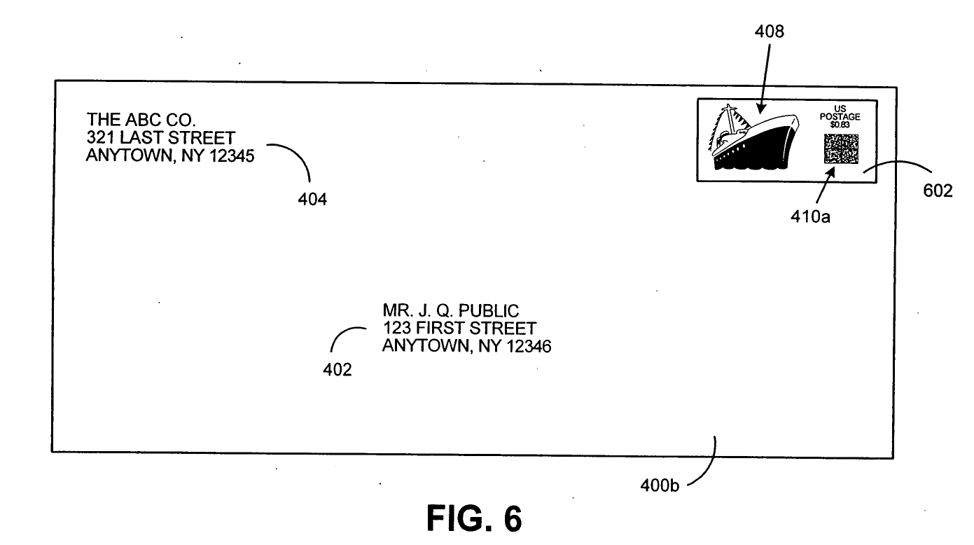

The mailpiece 400a shown in FIG. 5 is similar to the mailpiece of FIG. 4, except that the mailpiece 400a bears a postage meter indicium 406a that differs in size, location, proportion and orientation from the indicium 406 shown in FIG. 4. The mailpiece 400b shown in FIG. 6 is similar to the other two examples, except that the mailpiece 400b bears a pre-printed custom stamp 602 rather than the postage meter indicia 406 or 406a. The custom stamp 602 includes a custom image 408 and a data field 410a, but differs from the indicia 406, 406a in terms of size, proportion and layout.

The inventors point out that because of variations in location, orientation, layout, and/or size of custom stamps/indicia and in the custom images that may be included therein, there may potentially be challenges for the mailpiece handling equipment to properly locate a problematic image for the purpose of obscuring it. However, known techniques for finding 2-D barcodes may be employed to obtain a point of reference in the stamps. Moreover, the data encoded in the barcodes may include data which locates the image in the stamp relative to the barcode or relative to the edges of the mailpiece, and which indicates the dimensions of the image. The mailpiece handling equipment may use this information to navigate within the stamp from a reference point in the barcode, and may accordingly direct the printer 212 to print over the image without obscuring any other (or any important) portion of the stamp. As noted above, obscuring the image may be accomplished by applying ink to the image, by ink jet printing, for example. Alternatively, if the stamp was originally produced by thermal printing, the image may be obscured by applying heat to the thermal printing stock of the stamp, at the locus of the image and at a sufficiently high level to cause the image to be obscured.

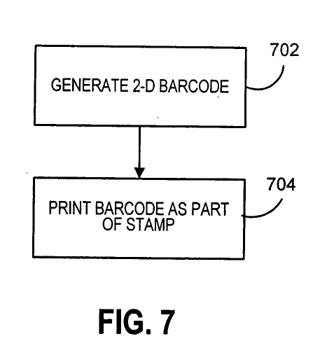

FIG. 7 is a flow chart that illustrates a process that may be carried out in the system of FIG. 1. At 702, a 2-D barcode image is generated. This may be done at the custom stamp server 102 (FIG. 1) or at a user's postage meter (not separately shown). The 2-D barcode contains data, of the sort described above, which indicates the location and dimensions of a custom image. The custom image is to be incorporated in a postage stamp with the 2-D barcode and the location is given relative to a reference point in or associated with the barcode. It will appreciated from previous discussion that the barcode may also contain identifiers for the user and the custom image. As an alternative, the location and dimensions of the image may be stored on the custom stamp server 102 (FIG. 1) and communicated to the postal authority infrastructure 112 together with identifiers of the offending image.

At 704, the user's postage meter or personal stamp printer prints a stamp which incorporates the 2-D barcode and the custom image.

In other embodiments, problematic images may be inked over by hand, after the mailpieces have been outsorted, and then the mailpieces may be returned to the mail stream for delivery to the recipient.

In some embodiments, the printing stock on which the stamp is printed may have a fluorescent or phosphorescent coating at the locus of the image, and the fluorescence/phosphorescence may be detected by the mailpiece handling equipment (via a sensor which is not shown) to identify the locus on the mailpiece to which ink or heat should be applied to obscure the image.

In still other embodiments, a distinctive border or the like is provided around or adjacent the image to allow the mailpiece handling equipment to find the image.

To make explicit a point that is implied by previous discussion, in some embodiments, only images that have been specifically found/reported to be problematic are removed from the mail stream. But in other embodiments, “guilt by association” may be applied to custom images. In other words, the system may act to remove from the mail stream any custom image produced by a user who is found or reported to have produced a problematic image.

The present invention may be thought of as a second line of defense against offensive custom stamp images, with pre-screening of custom images as the first line of defense. However, in some systems the pre-screening may be dispensed with, and the system may only use after-the-fact reporting with remedial action as described herein.

In some embodiments, the image identifier may be incorporated in the image in the form of a watermark that can be read by the mailpiece handling equipment. In some embodiments, the image identifier may be included in the stamp in a barcode that is separate from a conventional 2-D barcode. In some embodiments, metameric inks may be employed in printing postage stamps such that a conventional 2-D barcode is read when the mailpiece is exposed to one light source, and a barcode that contains the image identifier is read when the mailpiece is exposed to a different light source.

In some embodiments, problematic images may be detected by machine-analyzing the images themselves and matching them with images flagged as problematic.

Whenever the term “user identifier” or the like is used herein, it should be understood to encompass the serial number (e.g., meter number, stamp printer number) of a machine associated with a user.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
receiving a mailpiece in a stream of mail, the mailpiece having a postage stamp thereon, the postage stamp including an image;
detecting that the image is a problematic image; and
removing the image from the stream of mail.

2. The method according to claim 1, wherein the removing step includes obscuring part or all of the image.

3. The method according to claim 2, wherein the obscuring step includes applying ink to part or all of the image.

4. The method according to claim 2, wherein the image is printed on thermal-printing stock, and the obscuring step includes applying heat to the thermal-printing stock.

5. The method according to claim 1, wherein the removing step includes diverting the mailpiece from progress toward delivery.

6. The method according to claim 1, wherein the detecting step includes reading a code that identifies the image, the code included in the postage stamp.

7. The method according to claim 6, wherein the code that identifies the image is in the vicinity of the postage stamp.

8. The method according to claim 1, wherein the detecting step includes reading a code that identifies a user who applied the postage stamp to the mailpiece.

9. The method according to claim 1, further comprising:
receiving a report that a duplicate of the image was found to be problematic.

10. The method according to claim 1, further comprising:
receiving a report that a problematic image was used by a user who applied the postage stamp to the mailpiece.

11. The method according to claim 1, wherein the postage stamp includes a two-dimensional barcode, the barcode including data that indicates a location of the image in the postage stamp relative to the barcode.

12. The method according to claim 1, wherein the barcode includes data that indicates dimensions of the image.

13. An apparatus comprising:
means for detecting that an image in a postage stamp is problematic, the postage stamp on a mailpiece, the mailpiece in a stream of mail; and
means, responsive to the means for detecting, for removing the image from the stream of mail.

14. The apparatus according to claim 13, wherein the means for removing includes means for obscuring part or all of the image.

15. The apparatus according to claim 14, wherein the means for obscuring includes means for applying ink to the image.

16. The apparatus according to claim 14, wherein the means for obscuring includes means for applying heat to the image.

17. The apparatus according to claim 13, wherein the means for removing includes means for diverting the mailpiece from progress toward delivery.

18. The apparatus according to claim 13, wherein the means for detecting includes means for reading a code included in the postage stamp, the code identifying at least one of (a) the image, and (b) a user who applied the postage stamp to the mailpiece.

19. A method comprising:
generating a two-dimensional barcode; and
printing the barcode as part of a postage stamp, the postage stamp including an image, the barcode including data that indicates a location of the image in the postage stamp.

20. The method according to claim 19, wherein data included in the barcode indicates dimensions of the image.

21. The method according to claim 19, wherein the data indicates the location of the image relative to the barcode.

22. The method according to claim 19, wherein the data indicates the location of the image relative to edges of a mailpiece.

23. An apparatus comprising:
a control device for detecting problematic images and removing the problematic images from a mail stream; and
a server computer in communication with the control device for downloading to the control device data that identifies the problematic images and that indicates location and size of the problematic images relative to mailpieces that carry the problematic images.
